(19) United States
(12) Patent Application Publication
(10) Pub. No.: US 2003/0122392 A1
(43) Pub. Date: Jul. 3, 2003

(54) Vehicle console and storage system and method

(76) Inventors: Lance E. Larsen, Southfield, MI (US); Sangwon Choi, Holland, MI (US); Karen M. Hofmann, Glendale, CA (US)

Correspondence Address: John A. VanOphem, FOLEY & LARDNER, Suite 1000, 150 West Jefferson, Detroit, MI, 48226-4416, US

(21) Appl. No.: 10/039,227

(22) Filed: Jan. 2, 2002

(51) Int. Cl. B60R 7/04

(52) U.S. Cl. 296/24.1; 296/37.8

(57) ABSTRACT

A console and storage system for a vehicle is disclosed as located between two seats in the vehicle. The console and storage system includes a base, an armrest mounted with respect to the base and a first storage device captured between the base and the armrest. The armrest is configured to move between a deployed position and a stowed position. The first storage enclosure is removable when the armrest is not in the deployed position. The armrest is adjustable and has an accessory interface for coupling accessories to the armrest. A method for operating the console and storage system is also disclosed.

### FIELD OF THE INVENTION

The present invention relates to a console and modular storage system. More particularly, the present invention relates to a multi-function console and storage system having removable storage capability for use in a vehicle and interacting with an adjustable armrest.

### BACKGROUND OF THE INVENTION

Console systems for interiors in vehicles or the like are generally known. Such known console systems may include storage enclosures and/or armrests that are formed or mounted on a base. However, such known console systems are permanent in their configuration such that they are difficult to reconfigure (if reconfigurable at all) and lack adjustability and modularity. In particular the user of the console has little choice but for a console configuration as provided by the vehicle manufacturer. Further, it is known to have a console system for the interior in a vehicle and having a storage bin or tray or the like. Further, for sometime, it has been known that occupants of vehicles carry or bring purses, bags and the similar into the occupant compartment of a vehicle for carrying numerous items . However, many of the know console systems have significant draw backs for example, items located in a storage bin located in a console in a vehicle that an occupant wishes to take with her when leaving the vehicle must be transferred from the permanent console system to a hand bag or other similar carriers or must be hand carried. This can be a significant problem in view of the proliferation of electronic devices and media used by individuals.

Notwithstanding the above, there continues to be a need for a console system that may be relatively quickly and easily adjusted, configured, reconfigured or the like. Further, there continues to me a need for a console system and storage solution that will help an occupant of a vehicle better manage items stored in and taken from the vehicle. It would also be advantageous to provide an inexpensive, easy-to-manufacture, and aesthetically-pleasing console system. It would further be advantageous to provide a console system that is modular and yet provides suitable storage space in a vehicle. It would further be advantageous to provide a console system that can include control interfaces (e.g., audio, video, connectors, HVAC, etc.) and can use modular accessories (e.g., removable storage enclosures, tables, etc.). It would be desirable to provide for a console and storage -system having one or more of these and other advantageous features.

### SUMMARY OF THE INVENTION

A console and storage system according to the present invention is located in a vehicle and includes a base, an armrest coupled with respect to the base, and a first storage enclosure captured between the base and the armrest. The armrest is configured to move between a first or operative position and a second or stowed position. The first storage enclosure is removable when the armrest is not in the operative position.

The present invention also relates to a console and storage system for a vehicle that includes a second storage enclosure releasably coupled to the base by a second armrest configured to pivot between a deployed first operative position and a second stowed position. The second storage enclosure is also captured between the base and the second armrest when the armrest is in the first position, and is removable when the second armrest is not in the first position such as when the armrest is in the stowed position.

The present invention further relates to a console and storage system for a vehicle which includes a storage device or enclosure. The storage device operates as a means for retaining items of various types. The storage enclosure is preferably made of a relatively rigid material and includes a recess in a top portion of the storage device for receiving a extension or peg on one side of the armrest. When the armrest is in the first or deployed position the extension or peg on the underside of the armrest is received in the recess in the top of the storage enclosure which is received in the recess in the base of the console such that the storage device is trapped and locked in the base of the console.

The console and storage system according to the present invention further includes additional storage bins and tablets which alternatively interact with the armrest to provide additional storage and functionality to an occupant in the vehicle. Further, the armrest of the console and storage system of the present invention includes a drink holder and adjustable extension member for adjusting the cup holder. The armrest may have a plurality of devices which connect to the armrest and provide a variety of functions such as a tablet or the like.

Accordingly, it is a feature of the present invention to provide a console and storage system for use in a vehicle that is capable of providing modular storage to be used by an occupant of the vehicle. There is a further feature of the present invention in providing a modular storage enclosure for use in a console system in a vehicle wherein the modular storage enclosure is captured between a first member and a second member to prevent the modular storage enclosure from moving within the cabin of the vehicle.

The present invention and its various features and combinations of features are more fully shown and described in the following disclosed embodiments. Other ways in which the objects and features of the disclosed embodiments are accomplished will be described in the following specification or will become apparent to those skilled in the art after reading the following description and drawings. Such other ways are intended to fall within the scope of the disclosed embodiments if they fall within the scope of the claims which follow.

### BRIEF DESCRIPTION OF THE DRAWINGS

FIG. 1 is a perspective view of a console and storage system according to a preferred embodiment.

FIG. 2 is a perspective view of the console and storage system of FIG. 1 wherein one of the armrests is pivoted generally upright.

FIG. 3 is an exploded perspective view of the console and storage system of FIG. 1.

FIG. 4 is an exploded perspective view of the armrest according to a preferred embodiment.

FIG. 5 is a fragmentary exploded perspective view of the armrest and table interface according to a preferred embodiment.

### DETAILED DESCRIPTION OF THE PREFERRED EMBODIMENTS

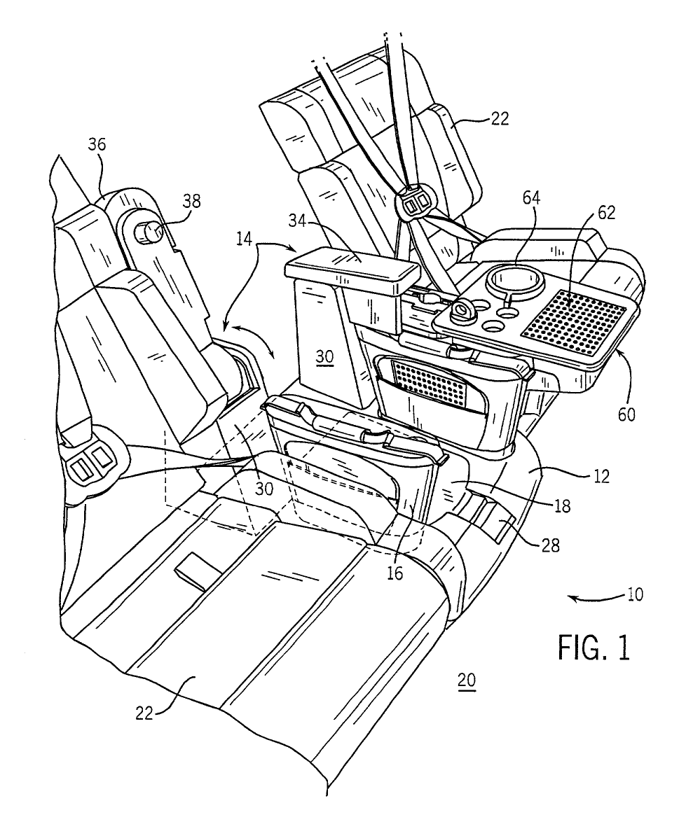

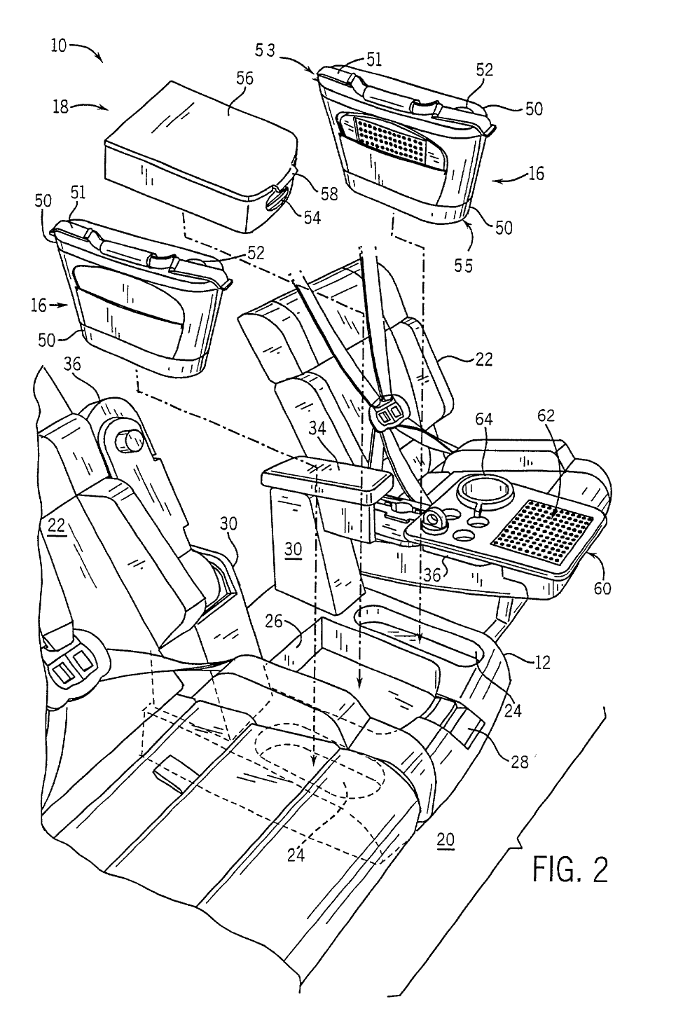

Referring generally to FIGS. 1 through 5 and in particular to FIGS. 1 through 3, there is shown a modular console 10 according to a preferred embodiment. Console 10 includes a base 12, a pair of multi-functional armrests (individually and collectively referenced as numeral 14), one or more removable storage enclosures (shown as a bag or tote 16, and a bin 18). Console 10 is configured to provide modular storage and multi-functional adjustable armrest support.

Base 12 is coupled using any appropriate mechanical connector or similar device to a floor 20 or other appropriate surface of a vehicle (not shown) between a pair of spaced apart seats 22 or other appropriate location. Preferably base 12 is configured to allow passage between seats 22 (i.e., the base 22 has a low profile to provide a “step through” pathway for vehicle occupants). Console 10 is positioned between what is intended as a non-first row or second row of seats 22 located behind a driver of the vehicle. Alternatively console 10 may be located in any of a variety of locations in the vehicle (e.g., between the front seats, between a third row of seats, in a cargo area, or the like). Additionally, while console 10 is shown positioned facing toward the front of the vehicle it is understood that console 10 may be positioned facing rearward of the vehicle or in any other appropriate or desired direction.

Base 12 preferably includes a pair of recesses (individually and collectively referenced as numeral 24) configured to receive the tote 16 (described below), a recess 26 configured to receive bin 18, and a latch 28 configured to releasably couple bin 18 to base 12 when disposed in recess 26. Recesses 24 are preferably formed to be complimentary with the form of the tote 16, but can be configured in any shape appropriate for receiving the tote 16. Similarly, recess 26 is configured to be complimentary to the outer perimeter of bin 18 to conformingly and securely receive bin 18. However, it should be understood that recess 26 could be configured to not be complimentary with the outer perimeter of bin 18, yet still be able to receive bin 18 therein and to have latch 28 still releasably coupled bin 18 to base 12 .

Preferably base 12 and recesses 24 and 26 are injection molded from a high density polythylene. The base 12 and recesses 24 and 26 are preferably formed in a single unit but may be separately formed and then connected or otherwise made integral. Alternatively, any other appropriate material can be used, including other thermoplastic resins such as polypropylene, other polyethylenes, acrylonitrile butadiene styrene (“ABS”), polyurethane nylon, any of a variety of homopolymer plastics, copolymer plastics, plastics with special additives, filled plastics, etc. Also, other molding operations may be used to form these components, such as blow molding, rotational molding, etc. Additionally, walls of the recesses may be formed including a compressible material (e.g., an elastomer) for improved gripping of the tote 16 or bin 18 or other accessory placed in the recesses 24 and 26.

Base 12 includes a support 30 for each armrest 14 connected to the base. The support 30 extends in an upward direction from the base 12 and the armrest 14 connected to the support 30 near the upper end of the support 30. The support 30 may have any appropriate shape or form for supporting the armrest 14. The support 30 is connected at its lower end to the base 12 in any appropriate manner or fashion using any known connection or coupling device appropriate for holding the support 30 to the base 12. The support 30 is preferably made of a material similar to the base 12 but may be made of any known or appropriate material as is understood in the vehicle interiors area.

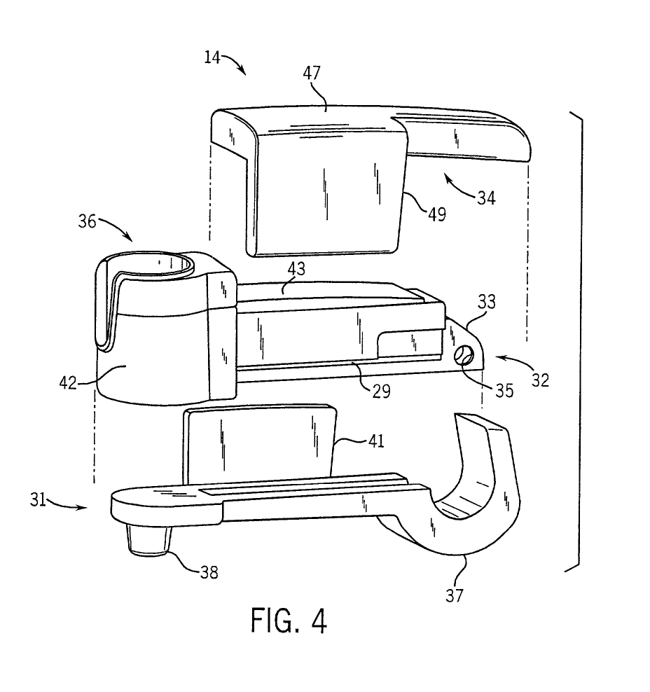

Armrests 14 are preferably coupled to supports 30 and configured to pivot between a first deployed operating position (e.g., a generally horizontal orientation) and a second stowed position (e.g., a generally upright orientation, etc.). Referring in particular to FIG. 4, armrest 14 includes a pivoting member 32, a base member 31, a telescoping or extendable member 36, a cover member 34, and a locating peg 38.

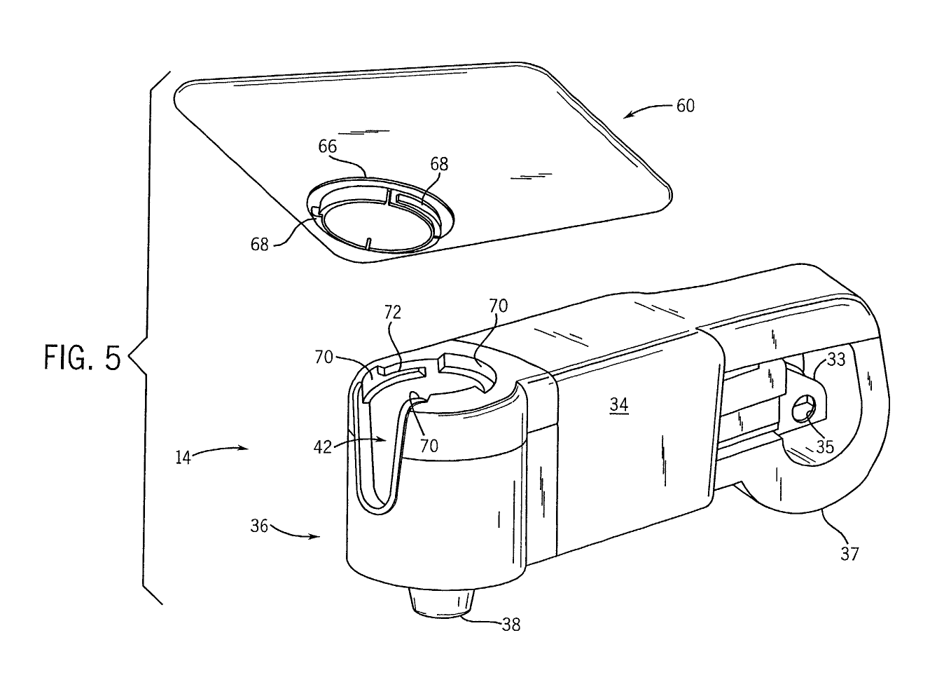

Referring to FIGS. 4 and 5, pivoting member 32 includes a pair of flanges 33 that are coupled to supports 30 with a dowel or rod (not shown) that engages apertures 35 in flanges 33 and is connected or anchored to support 30 as would be understood by a person of ordinary skill in the art. Armrest 14 is configured to lock in place when placed in a particular position (e.g., the deployed position, the stowed position, or the like). Using spring-loaded ballbearing in the dowel or rod to engage detent in the aperture 35 to hold armrest 14 in place until a sufficient amount of force is exerted to overcome the fore required to remove the spring-loaded ballbearing from the detent. It should be further understood that it is possible for the armrest 14 to be connected or configured to move between the deployed and the stowed position in a translating movement or in any other appropriate movement. Further, it should be understood that it is possible to use any known or appropriate type of connection and means for moving the armrest 14 between the deployed position or the stowed position.

The armrest 14 preferably includes a base or other similar member 31 mounted to the underside of pivoting member 32. The base member 31 is configured to provide additional support (e.g., flexural) to armrest 14 and is attached to pivoting member 32 by a plurality of fasteners (e.g., screws, rivets, or any other fastener appropriate for fastening, holding or connecting such as by heat staking, welding, adhesives, or the like). Base member 31 includes an extension or locating peg 38 and a shroud member 37. The locating peg 38 is preferably integrally and unitarily formed with the base member 31 but alternatively may be connected to or added on the base member 31 or other portion of the armrest 14 to be made into an integral unit. Further, the locating peg 38 preferably has a round cylindrical shape and is made of a material similar to the armrest 14, the support 30 and the base 12. The locating peg 38 is preferably designed to interact with the tote 16 as more fully described below.

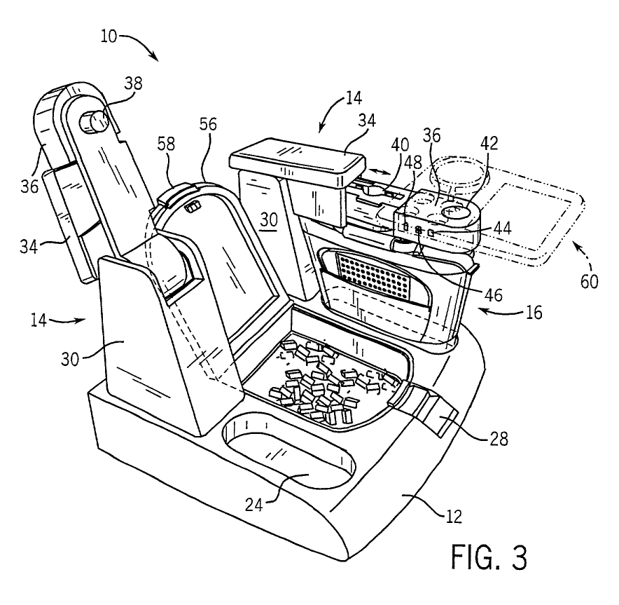

Shroud member 37 is configured to at least partially cover or surround the interface between armrest 14 and support 30 (i.e., the pivot axis and connection). As such, shroud member 37 is intended to obscure the pivot axis (i.e., the aperture 35 and the related rod) from view when armrest 14 is pivoted from the deployed position and toward the stowed position (as shown in FIG. 3) to shield potential pinch points, and to provide a positive aesthetic. A channel 39 is provided in the top portion of base member 31, and is longitudinally configured to receive a bottom extension portion 27 of pivoting member 32. A side member 41 is mounted to base member 31 and configured to obscure the side of armrest 14 and may alternatively provide a cushion in the form of a foam pad (not shown) attached to the relatively rigid structure (e.g., for support) of the side member 41. The side member 41 is disclosed as being unitary with the base member 31 but may also be made integral in any known or appropriate fashion.

According to an exemplary embodiment, extendable member 36 is coupled or connected to pivoting member 32 with a pair of conventional slide or track systems 29 (e.g., interlocking channels, drawer-type slides, or other similarly appropriate connection system that allows for sliding engagement). Extendable member 36 is configured to move in a first or forward direction and in a second or backward direction on track system 29 to a position desired by an occupant. Extendable member 36 may include any of a variety of accessories or interfaces such as a pen holder 40, a cup holder 42, a head phone jack 44, an electrical interface 46 (e.g., a power interface, a computer plug-in interface such as a teleport, serial port, USB port, or the like), speakers, controls 48 (e.g., for seat, ventilation system, audio or video equipment, lighting, etc.), and the like as shown in FIG. 3.

The armrest 14 further includes a support member 43 coupled to base member 31 or alternatively pivoting member 32. Support member 43 is disposed between cover member 34 and pivoting member 32, and is configured to provide support for cover member 34 when extendable member 36 is extended in the forward direction.

Cover member 34 is mounted to pivoting member 32 similarly to base member 31 and is configured to provide support to objects or an occupant's appendage (e.g., an arm) placed thereon. Cover member 34 preferably includes a cushion 47 located on the top or upper portion thereof. According to a preferred embodiment, cover member 34 has a side member 49 so that it forms generally a “Lshaped” structure. Preferably, a pair of clips attached (e.g., welded, fastened, adhered or with any other way made integral) to base member 31 engage cover member 34 to couple cover member 34 to base member 31. Cushion 47 is configured to provide a compressible support surface using any appropriate material (e.g., for comfort) but is preferably, made of a covered foam, sponge, or other compressible material. The cover for the cushion 47 may also include an outer skin made of leather, vinyl, fabric, or other known or appropriate material. Side member 49 is shown disposed proximal the center of console 10 and side member 41 is shown disposed proximal the adjacent seat 22. It will be understood by a person of ordinary skill in the art that it is possible to reverse the direction and dependency of side members 49 and 41 with the respect to base member 31 and cover member 34.

According to a preferred embodiment, tote 16 is made from any appropriate or known material having an appropriate stiffness or re-enforcement member fit for the particular application and tote 16 further preferably includes end caps 50, a top 53 and a bottom 55 and a removable strap 51. The end caps 50 are preferably plastic injection molded of any known or appropriate material and may be made of a material similar to the material used for the base 12. The bottom 55 of tote 16 is preferably configured to correspond to or even form fit within recess 24 in base 12. The top 53 is preferably made of a molded plastic material appropriate for the application and is made integral with the tote 16 and using any appropriate or known material and process. The top 53 of tote 16 includes a molded recess 52 or other appropriate mating connection for receiving peg 38 located on the underside of armrest 14. Preferably, peg 38 extends downwardly from the underside of pivoting member 32 or from the base member 31 to engage to tote 16. Alternatively, peg 38 may extend from the underside of extendable member 36 or other portion of armrest 14. Tote 16 includes one or more storage compartments for receiving and storing any of a variety of items (e.g., toys, a “Go-pad”, books, maps, food, electronic devices, etc.) and the caps 50 may be removably attached to the tote 16 in order to provide access to one or more storage compartments within the tote 16. Alternatively, the top 53 of tote 16 is hingedly or otherwise movingly connected to the tote 16.

Bin 18 is configured to fit into recess 26 in base 12 and be sturdy enough to support a person standing on it (e.g., provides a step through between the seats). Bin 18 preferably includes a handle 54 and a lid 56. A latch 28 preferably secures bin 18 to the base 12 within recess 26 by releasably coupling to handle 54 on bin 18. Preferably, lid 56 is hingedly connected to the top of bin 18 and is secured in a closed position by a latch 58 using any known or appropriate connection or coupling design.

Any of a variety of accessories may be configured to couple to armrest 14 to provide a modular system. According to a preferred embodiment, a tablet or table 60 (shown as a removable tablet 60) couples to armrest 14. Tablet 60 may provide any of a variety of functions, including a work surface, an eating or play surface 62, a cup holder 64 and the like. According to an exemplary embodiment shown in FIG. 5, tablet 60 is mounted to cup holder 42 by engagement of a mounting member 66 inserted into cup holder 42.

The armrest 14 preferably has a selectively adjustable interface which includes mounting member 66 mounted in an aperture in tablet 60 and includes a pair of keys or flanges 68 that engage guides 70 and keyway or channel 72 in cup holder 42. To mount tablet 60 to armrest 14, the flanges 68 are inserted into the guides 70 until aligned with the channels 72. Tablet 60 is then rotated through a given distance (e.g., 90°) so that flanges 68 are locked or captured in the channels 72. According to one alternative embodiment, mounting member 66 may include threads configured to engage corresponding and mating threads in cup holder 64 of tablet 60. Preferably, mounting member 66 is not rigidly secured to tablet 60 so that tablet 60 can swivel or rotate relative to mounting member 66 and armrest 14. When the tablets 60 are mounted to both armrests 14, the tablets 60 can be configured to rotate inwardly to provide a surface that spans the center of the console 20.

According to an alternative embodiment, mounting member 66 is configured to provide a breakaway engagement between tablet 60 and armrest 14 so that tablet 60 disengages cup holder 64 upon exertion of a predetermined amount of force such as that generated during a collision or other potentially harmful event or by an individual's weight bearing down on the surface to prevent the tablet 60 or armrest 14 from breaking. The mounting member 66 is preferably made from a compressible material such as rubber, elastomer, or the like, to provide frictional resistance to rotation of tablet 60 relative to mounting member 66 and of flanges 68 relative to channels 72, and to provide a breakaway engagement between tablet 60 and armrests 14. According to a particularly preferred embodiment, mounting member 66 is made from a relatively high durometer (e.g., a material having about a 60-120 durometer and more preferably a material having about a 80-100 durometer, and even more particularly a material having about 90 durometer) cast rubber or urethane material.

It is also important to note that the construction and arrangement of the elements of the console with modular storage and adjustable armrest as shown in the preferred and other exemplary embodiments are intended only to be illustrative. Although only a few embodiments of the present invention have been described in detail in this disclosure, those skilled in the art who review this disclosure will readily appreciate that many modifications are possible (e.g., variations in sizes, dimensions, structures, shapes and proportions of the various elements, values of parameters, mounting arrangements, materials, colors, orientations, etc.) without materially departing from the novel teachings and advantages of the subject matter recited in the claims. For example, the modular concepts disclosed herein may be used for any of a variety of vehicles with any of a variety of combinations, and orientations. Accordingly, all such modifications are intended to be included within the scope of the present invention as defined in the appended claims. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and/or omissions may be made in the design, operating conditions and arrangement of the preferred and other exemplary embodiments without departing from the spirit of the present invention as expressed in the appended claims.

What is claimed is:

1. A console and storage system for a vehicle, the console and storage system comprising:
a base;
an armrest mounted with respect to the base, the armrest configured to move between a deployed position and a stowed position;
a first storage device captured between the base and the armrest, wherein the first storage device is removable when the armrest is not in the deployed position.

2. The console and storage system of claim 1 wherein the base includes a first recess configured to receive the first storage device.

3. The console and storage system of claim 1 further comprising a support extending from the base, the armrest mounted to the support.

4. The console and storage system of claim 1 further including a second storage device removably coupled to the base.

5. The console and storage system of claim 3 wherein the base includes a second recess configured to receive the second storage device.

6. The console and storage system of claim 4 wherein the base includes a second recess configured to receive the second storage device.

7. The console and storage system of claim 1 further including a first mating connection member mounted thereon, and the first storage device including a second mating connection member, the coacting with the second mating connection member to secure the first storage device to the console system when the armrest is in the deployed position.

8. The console and storage system of claim 7 wherein the first mating connection member is a peg extending downwardly from the armrest.

9. The console and storage system of claim 7 wherein the first storage device has a top and the second connection member comprises a recess located and the recess is in the top of the first storage device.

10. The console and storage system of claim 1 wherein the armrest includes an accessory interface.

11. The console and storage system of claim 10 wherein the accessory interface is slidably coupled to the armrest.

12. The console and storage system of claim 10 wherein the accessory interface includes a cup holder.

13. The console and storage system of claim 10 wherein the accessory interface includes a pen holder.

14. The console and storage system of claim 10 wherein the accessory interface includes a control for adjusting an accessory .

15. The console and storage system of claim 10 wherein the accessory interface includes one or more electronic interfaces.

16. The console and storage system of claim 10 further including an accessory mountable in the accessory interface.

17. The console and storage system of claim 16 wherein the accessory is a tablet.

18. The console and storage system of claim 16 wherein the accessory includes a mounting member configured to engage the accessory interface.

19. The console and storage system of claim 18 wherein the mounting member includes a flange configured to engage a corresponding channel in the accessory interface.

20. The console and storage system of claim 10 wherein the mounting member is configured to disengage from the mounting interface upon application of a sufficient amount of force.

21. A console system for a vehicle, the console system comprising:
a base;
an armrest mounted with respect to the base, the armrest configured to move between a deployed position and a stowed position, wherein the armrest includes a mating connection member for connection with a first storage device to be captured between the armrest and the base.

22. The console system of claim 21 further comprising the first storage device wherein the armrest includes a first mating connection member located thereon and the first storage device includes a second mating connection member located thereon.

23. The console system of claim 21 wherein the base includes a recess configured to receive the first storage device.

24. The console system of claim 21 wherein the base includes a latch configured to releasably couple the second storage device to the base.

25. The console system of claim 21 further including a peg connected to the armrest and the first storage device includes a recess and wherein the first storage device is secured to the console.

26. The console system of claim 25 wherein the peg extends downwardly from the armrest and the recess is on a top of the first storage device.

27. The console system of claim 21 wherein the armrest includes a selectively adjustable accessory interface.

28. The console system of claim 27 wherein the accessory interface is slideably coupled to the armrest.

29. The console system of claim 27 wherein the accessory interface includes a cup holder.

30. The console system of claim 27 wherein the accessory interface includes a utensil holder.

31. The console system of claim 27 wherein the accessory interface includes a control for adjusting an accessory.

32. The console system of claim 27 wherein the accessory interface includes an electronic connection interface.

33. The console system of claim 27 further including an accessory mountable in the accessory interface.

34. The console system of claim 33 wherein the accessory is a tablet.

35. The console system of claim 32 wherein the accessory includes a mounting member configured to engage the accessory interface.

36. The console system of claim 35 wherein the mounting member includes a flange configured to engage a corresponding channel in the accessory interface.

37. The console and storage system of claim 35 wherein the mounting member is configured to disengage from the mounting interface upon application of a sufficient amount of force.

38. A storage system for use in a vehicle having a seat, the storage system comprising:
a base to be located proximate the seat having a first recess and a second recess;
a cover member for mounting with respect to the seat and the base the configured cover being member to move between a deployed position and a stowed position; and
a first storage device configured to be captured between the base and the cover member when the cover member is in the deployed position.

39. The storage system of claim 38 wherein the storage system further comprises an armrest having a peg configured to engage a recess on a top of the first storage device to secure the first storage device in the vehicle.

40. The storage system of claim 38 wherein the cover member includes a selectively adjustable accessory interface.

41. A console system for a vehicle, the console system comprising:
a base;
a first member coupled to the base, the first member configured to move between a first position and a second position; and
a first storage device to be captured between the base and the first member when the first member is in the first position, the first storage device being removable when the first member is not in the first position.

42. The console system of claim 41 wherein the base includes a recess configured to receive the first storage device.

43. A method for operating a console and storage system for a vehicle, the console and storage system including a base for connecting to the vehicle, an armrest coupled with respect to the base, the armrest configured to move between a first position and a second position, a first storage device designed to be captured between the base and armrest when the armrest is in the first position, the first storage device designed to be removable from the base when the armrest is in the second position, wherein the method of operating the console and storage system comprises the following steps;
moving the armrest from the first position; and
removing the first storage device.

44. The method of operating the console and storage system of claim 43 further comprising the step of locating the first storage device on the base and moving the armrest to the first position to secure the first storage device between the armrest and the base.

45. The method of operating a console and storage system according to claim 43 wherein the console and storage device further includes a second storage device separately located on the base from the first storage device, the method further comprising the step of removing the second storage device from the base separate from the first storage device.

46. The method of operating a console and storage device according to claim 43 wherein the console and storage device further includes an accessory interface integrated with the armrest, the method of operating the console and storage device further comprising the step of connecting an accessory to the accessory interface of the console and storage device.
